(19) United States
(12) Patent Application Publication
(10) Pub. No.: US 2004/0085456 A1
(43) Pub. Date: May 6, 2004

(54) Camera with viewfinder for image communication

(76) Inventors: Chung-Seon Kwag, Seoul (KR); Min-Hee Kwag, Seoul (KR)

Correspondence Address: G W i P S, Kangnam, P. O. Box 2301, Seoul, 135-242, KR

(21) Appl. No.: 10/400,699

(22) Filed: Mar. 28, 2003

(30) Foreign Application Priority Data
Nov. 6, 2002 (KR) 2002-0068514

(51) Int. Cl. H04N 7/00; H04N 11/00; H04N 5/222

(52) U.S. Cl. 348/211.11; 348/552; 348/333.01

(57) ABSTRACT

A video communication system employing a plurality of cameras with viewfinders comprises a camera with a viewfinder mounted on a computer monitor for recording an image in front of the monitor, a plurality of cameras with viewfinders posted at each site for local image and voice information, a communication interface interconnecting a computer processor and the plurality of cameras through connecting codes or a wireless system. The camera also equips an image-sensing unit, an auxiliary memory unit, a control unit and a transforming unit. A process for video communication applied to the computer processor employing a plurality of cameras with viewfinders includes a main control program, a subroutine for image communication and a subroutine for photographing. The subroutine for photographing mode further comprises a subroutine for still-image mode (S320), sequential still-image mode (S340), animation mode (S360), voice recording mode (S380) and searching mode (S390).

### BACKGROUND OF THE INVENTION

1. Field of the Invention

The present invention relates to a camera that is equipped with a viewfinder for image communication through the Internet. More particularly, a plurality of cameras is monitored, and image and voice information from specific camera is selectively monitored and transmitted to a computer processor for image communication between remote operator sites.

2. Description of the Prior Art

Generally, a camera for image communication is mounted inside of a computer monitor to record image and voice information. The image recorded by the camera is displayed on a viewfinder screen, and both the image and voice information is processed by a computer processor for transmission to a remote operator site. An image taken by a digital camera is usually displayed on a monitor through a USB, or another interface, for monitoring image quality.

Most cameras mounted inside of a computer monitor can only record images close to or in front of the monitor. If an object were located farther away, outside of the range of the camera, the operator would have to place the computer monitor close to the object in order to record an image. Furthermore, a camera viewfinder screen generally is not big enough to display both an image and other information at the same time.

Even though a digital camera (or still camera) equips a viewfinder such as an LCD or other optical device to instantly display an image, it is impossible to display other information on the viewfinder screen at the same time. Furthermore, a separate voice-communication device must be employed between the computer processor and the remote site camera.

For image communication or videoconferences, conventional devices cannot connect more than two cameras to a single computer processor. If an object is located far away from the computer monitor, which houses the camera, it is very difficult to record an image of the object.

Therefore, a new concept of image communication or videoconference systems is developed for selectively monitoring and transmitting an image recorded by a specific camera among a plurality of cameras.

### SUMMARY OF THE INVENTION

In order to solve the aforementioned problems, an object of the present invention is to provide a video communication system employing a plurality of cameras with viewfinders. The video communication system comprises a camera with a viewfinder mounted on a computer monitor for recording an image of an operator, a plurality of cameras with viewfinders posted at each site for recording remote site image and voice information, and a communication interface connecting a computer processor and the plurality of cameras via connecting codes or a wireless system.

A configuration of the camera comprises an image-sensing unit, an auxiliary memory unit, a control unit and a transforming unit. The image-sensing unit is equipped with an analog-digital (A/D) converter for transforming image information from an analog signal to a digital signal. The auxiliary memory unit temporarily stores the converted digital signal. The control unit transmits the converted image information to a computer processor. The control unit receives voice information through the microphone and transforms it to a voice signal. The transforming unit transforms the image and voice information received from the control unit to a standard signal, which is then transmitted to a computer processor through the communication interface.

Another object of the present invention is to provide a process for video communication by using a computer such as a laptop or desktop PC. The process of video communication comprises the following steps: connecting a specific camera among a plurality of cameras (S100); activating a software program (S/W) called Corder/Decorder (CODEC) in the computer processor which corresponds to the connected camera (S102); searching for the DATE file of the selected camera in the memory unit (S104); determining whether the DATE file of the selected camera exists in the memory unit (S106), and, if not, creating a new file to store the image information in the memory unit (S107), or, alternatively, if the DATE file does exist, entering the input signal either for image communication or photographing (S108); establishing either image communication mode or photographing mode (S110); activating a subroutine of image communication (S200) or photographing (S300), and, depending on the selection made, receiving and storing the image and voice information from the selected camera for displaying and monitoring on the viewfinder screen (S400).

The subroutine for image communication further comprises the following process: displaying the image communication mode on the viewfinder screen (S201); setting switch-on mode for the selected camera among the plurality of cameras (S203), and, if the selected camera is not detected in shutter-on mode, displaying the image from the camera mounted on the computer monitor while searching for another available camera (S204), or, alternatively, if the selected camera is detected in shutter-on mode, displaying the image transmitted from the selected camera (S205).

The subroutine for photographing mode comprises the following process: displaying photographing mode on the camera viewfinder (S301); setting button-on mode for the selected camera among the plurality of cameras (S303); activating the subroutine for a still-image (S320); pressing the button one time (S305) to establish sequential still-image mode (S340); pressing the button one more time (S307) to establish animation mode (S360), or, alternatively, pressing the button promptly twice (S307) at initial mode (S303) to establish a subroutine of animation mode (S360); pressing the button one more time (S309) to establish voice recording mode (S380), or, alternatively, pressing the button promptly three times (S307) to establish a subroutine of voice recording mode (S380) from initial mode (S303); pressing the button one more time (S311) to establish searching mode (S390); or, alternatively, from initial mode (S303), pressing the button promptly four times (S311) to establish searching mode (S390). As the subroutine is completed, processing returns to the main program (S400).

The subroutine of animation mode (S360) comprises the following process: displaying the subroutine of animation mode on the viewfinder screen (S361); storing time information in the organized DATE and HOUR files of the memory unit (S363); checking whether a selected camera has switch-on status for activation (S365), and, if not, setting standby mode for the selected camera, or, alternatively if the selected camera is in switch-on mode, instructing it to record moving image and voice information (S367); storing the moving image with sounds, date, hour and site in an auxiliary memory unit (S369); compressing and transforming the stored moving image via the control unit (S371); transmitting the compressed moving image to the computer processor via the communication interface 25; displaying it on the viewfinder screen (S373); and returning to the main program.

The subroutine for searching mode (S390) comprises the following process: displaying searching mode on the viewfinder screen (S391); inputting data, such as the camera site number and the date the image was recorded, which data is displayed on the screen from the organized DATE file in the memory unit (S393); and retrieving the proper image information on the viewfinder screen (S395).

### BRIEF DESCRIPTION OF THE DRAWINGS

FIG. 1 is a schematic drawing illustrating an image communication system in which a laptop computer is connected to a plurality of cameras with viewfinders.

FIG. 2 is a schematic drawing illustrating a camera with a viewfinder for an image communication system.

FIG. 3 is a block diagram illustrating an image process unit.

FIG. 4 is a flowchart illustrating a process for image communication applied to a laptop computer connected to a plurality of cameras with viewfinders to selectively monitor and control image and voice information recorded by a selected camera with a viewfinder.

FIG. 5 is a subroutine for image communication mode.

FIG. 6 is a subroutine for photographing mode.

FIG. 7 is a subroutine for still-image mode.

FIG. 8 is a subroutine for sequential still-image mode.

FIG. 9 is a subroutine for animation mode.

FIG. 10 is a subroutine for voice recording mode.

FIG. 11 is a subroutine for searching and retrieving mode.

### DETAILED DESCRIPTION OF THE PREFERRED EMBODIMENTS

To achieve the aforementioned objective, a plurality of cameras 26 equipped with viewfinders 10 are employed for a video communication system. A camera 26 is posted at each site for recording local image and voice information. Each camera 26 is connected to the main computer processor 30 through a communication interface 25 via connecting wires or a wireless system. Image information taken from each site is displayed on the local viewfinder and transmitted to the computer processor 30, which displays such information on the main viewfinder mounted on the computer monitor. Then, an operator selectively monitors specific image information at the main viewfinder among the images submitted from each site. The images transmitted from each site are stored in the storage unit of the computer processor. The monitored image information is transmitted to the remote communicator according to the operator's instruction. Thus, video communication is carried out though a laptop or desktop PC with multiple camera systems.

A typical camera for video communication comprises a lens for focusing on an object whose image is to be recorded, an image sensing unit for transforming image information to a digital signal, an auxiliary storage unit for storing transformed image information, a microphone for transmitting voice information, a controller for controlling and transmitting image and voice information to the computer processor, a transmitting transformer for transforming and transmitting image and voice information to the remote communicator.

The camera is internally equipped with a microphone to transmit voice information to the computer processor via a communication interface. Transmitted voice information is stored in an auxiliary storage unit.

According to an embodiment of the present invention, a video communication system, which employs a plurality of cameras with viewfinders, is described in detail, accompanied with drawings.

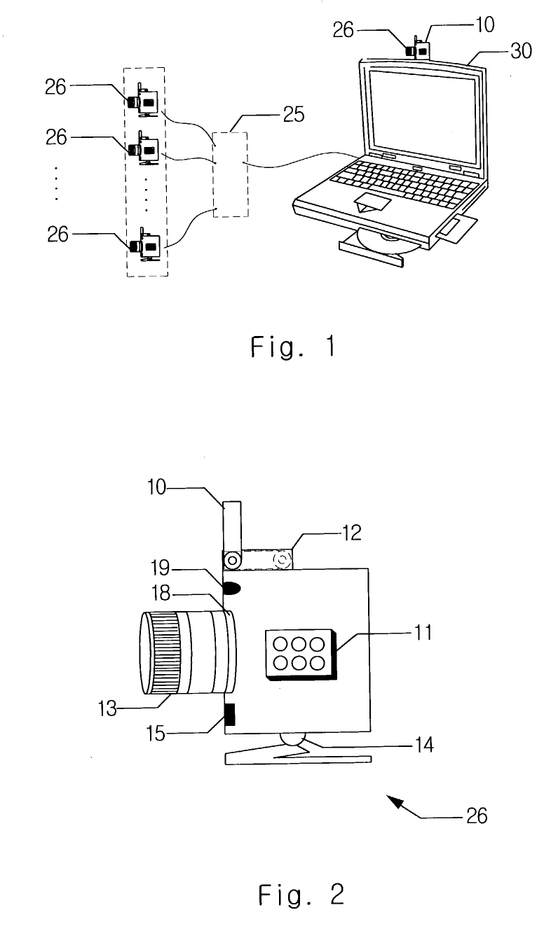

Referring to FIG. 1, a video communication system comprises a camera 26 with a viewfinder mounted on a computer monitor for recording an image of an operator, a plurality of cameras 26 with viewfinders posted at each site for recording local image information, and a communication interface 25 connecting a computer processor 30 and the plurality of cameras 26. A camera 26 is selected among the plurality of cameras based on an operator's instruction to perform a photographing function. The communication interface 25 disposed between the computer processor 30 and the plurality of cameras 26 is connected through connecting codes or a wireless system. Each camera 26 is equipped with a microphone for transmitting voice information to the computer processor via the communication interface 25. Transmitted voice information is also stored in the auxiliary storage unit in the computer processor.

A control switch 11 mounted on the lateral side of the camera enables an operator to turn the power on or off, and selectively operate a recording function of the still-images, sequential still-images, animation, voice, and capturing function.

Depending on the function the operator selects, the camera photographs and displays an image on the viewfinder. Image information taken by each camera is continuously transmitted to the computer processor via the communication interface 25. The transmitted image information is stored under the identified camera site file in the storage unit of the computer processor or hard disk. The stored image information can be retrieved when necessary to display or transmit to the remote site operator.

The communication interface 25 can make use of a Universal Serial Bus (USB), USB II, IEEE1394 or any other kind of communication standard device. A desktop or laptop computer processor unit (CPU) equipped with an Internet browser, Pentium II to IV, Windows 98, and 64 Mb of memory can be used for the video communication system.

As shown in FIG. 2, the camera 26 comprises a viewfinder 10, an attachment device 12, a lens 13, a swivel mount 14, a microphone 19, a speaker/earphone jack 15, a control switch panel 11 and a lens-mount device 18. The viewfinder 10 is a displaying device such as an LCD, TFT or tiny optical tube for displaying an image. Image information recorded through the lens is transformed to a digital signal and transmitted to the computer processor through the communication interface 25.

The attachment device 12 is used for attaching or removing the viewfinder 10 from the camera. The swivel mount 14 is used for controlling and fixing the camera angles to focus on an object. The lens-mount device 18 is compatible with a variety of sizes of lenses. The microphone 19 enables the recording of voice information along with image information. The speaker/earphone jack 15 is used for communicating voice messages. The control switch 11 mounted on the lateral side of the camera enables an operator to turn the power on or off, select operations, and selectively record still-images, sequential still-images, animation, and voice information.

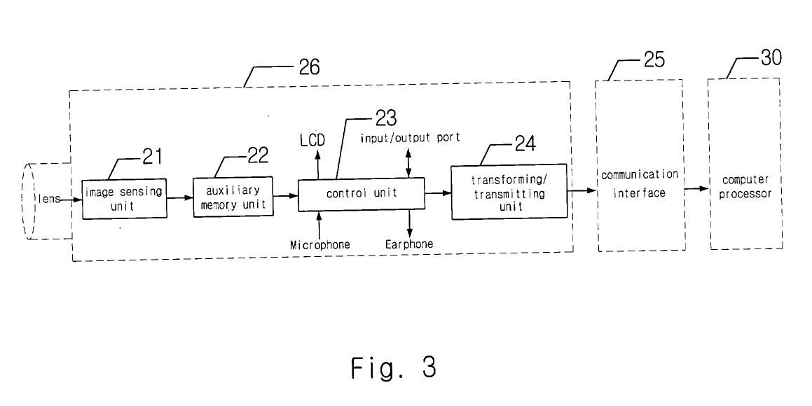

Referring to FIG. 3, the camera for video communication consists of an image-sensing unit 21, an auxiliary memory unit 22, a control unit 23 and a transforming unit 24. The image sensing unit 21 is internally equipped with an analog-digital (A/D) converter for transforming an analog signal of the image information received through the lens to a digital signal. The auxiliary memory unit 22 temporarily stores the converted digital signal prior to its being compressed by the control unit 23. The control unit 23 controls the image sensing unit 21, the auxiliary memory unit 22 and the transforming unit 24 for transmitting the converted image information to the computer processor 30 and displaying it on the viewfinder screen 10. The control unit 23 receives voice information through the microphone 19 and transforms it to an electric signal. The transforming unit 24 transforms image and voice information received from the control unit 23 to the standard USB, USBII or IEEE1394 signal. The standard signal is then transmitted to the computer processor 30 via the communication interface 25. Then, the image information can be displayed on the viewfinder screen.

According to the operator's instruction, one of the functions—image communicating, recording, photographing or capturing—is selectively performed and monitored.

Hereinafter, the process for operating an image communication of the present invention is described in detail, accompanied with drawings and programming flowcharts.

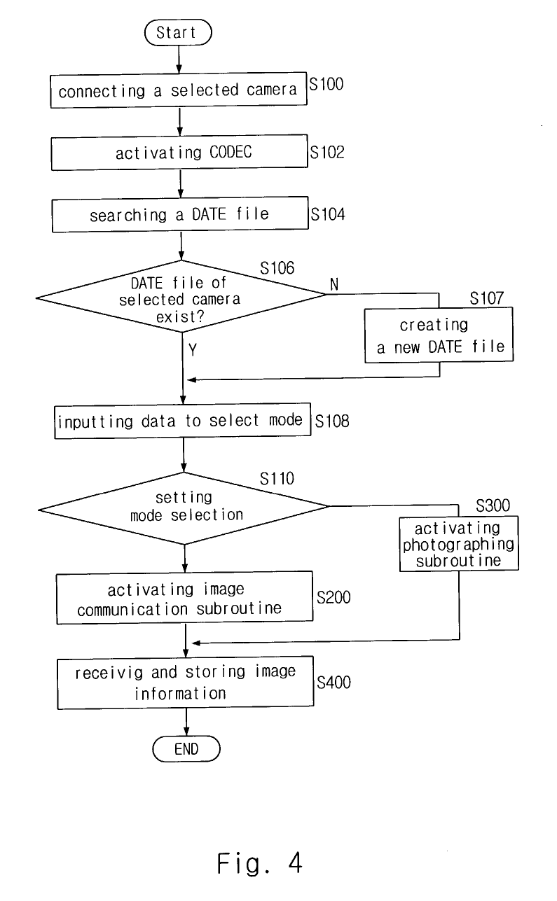

Referring to FIG. 4, the flowchart of the main computer program shows the process of image communication applied to a laptop computer connected to a plurality of cameras with viewfinders. A computer processor 30 such as a laptop or desktop PC is connected to at least one camera 26 among the plurality of cameras (S100). A software program (S/W) of Corder/Decorder (CODEC) in the computer processor 30 is activated for corresponding to the connected camera (S102). A DATE file of the selected camera is searched for in the memory unit (S106) of the computer processor (S104). If a DATE file of the selected camera does not exist in the memory unit, a new DATE file is created to store image information (S107). The computer processor 30 receives a selected functional signal for performing either image communication or photographing (S108). The computer processor 30 establishes either image communication mode or photographing mode, depending on the operator's instruction (S110). If image communication mode is selected, a subroutine for image communication mode is displayed (S200). The image taken from a selected camera is transmitted to the computer processor for displaying on the viewfinder screen. If photographing mode is selected, a subroutine for photographing mode is displayed (S300). When the received information is stored in the memory unit, the main program is terminated (S400).

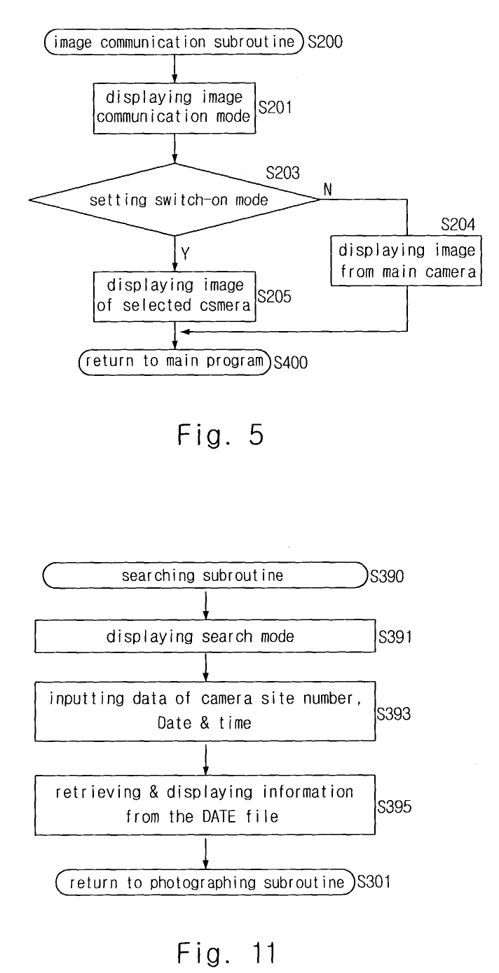

Referring to FIG. 5, a subroutine for image communication is described in great detail. When image communication mode is selected according to the operator's instruction, the camera viewfinder displays image communication mode (S201). At the same time, the selected camera is set to switch-on mode (S203). If the selected camera is not detected in shutter-on mode, displaying the image from the main camera mounted on the computer monitor while searching for the next available camera (S204). If the selected camera is detected in shutter-on mode, according to the operator's instruction, the computer monitor displays the image transmitted from the selected camera (S205). Then, the image and voice information are stored in a designated HOUR file, which is stored in the lower directory of the DATE file. The organized DATE and HOUR file system is convenient for storing and retrieving specific information. As the subroutine is completed, the process returns to the main program (S400).

On the other hand, it is also possible to store image and voice information in a portable memory device such as an MP3 player, a hard disk or a CD, through the communication interface 25, while a selected camera is communicating with the computer processor 30.

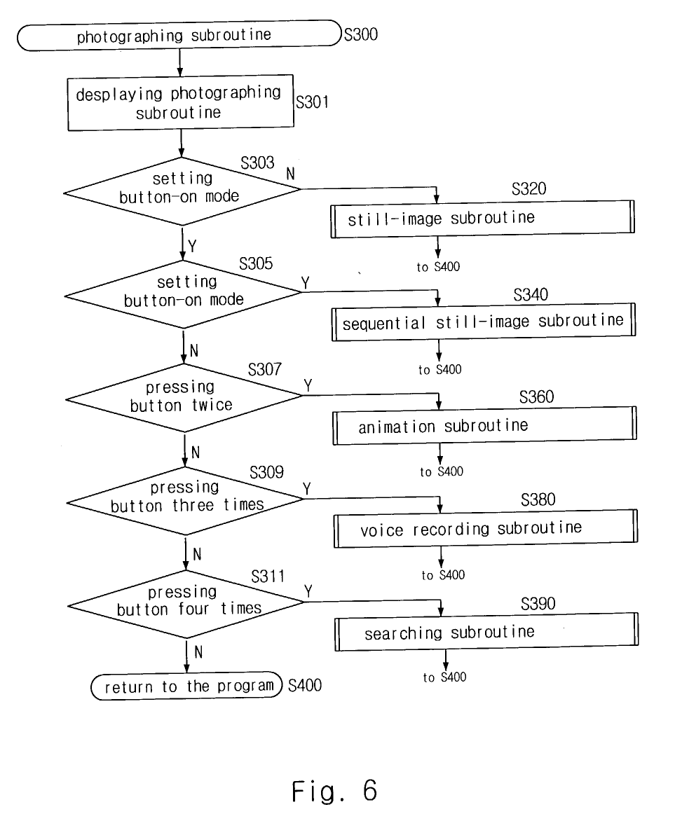

Referring to FIG. 6, a subroutine for photographing is described in detail. When photographing mode is selected according to the operator's instruction, the camera viewfinder displays photographing mode (S301). At the same time, the selected camera is set to button-on status (S303). When button-on status is established, a subroutine is automatically activated for still-image mode (S320).

At this point, the button is pressed one time (S305) to establish sequential still-image mode (S340). Alternatively, from initial mode (S301), the button is promptly pressed once (S305) to establish sequential still-image mode (S340).

While sequential still-image mode (S340) is activated, the button may be pressed one more time (S307) to establish animation mode (S360). Alternatively, the button is promptly pressed two times (S307) from initial mode (S301) to establish a subroutine of animation mode (S360).

During activation of animation mode (S360), the button may be pressed one more time (S309) to establish voice-recording mode (S380). Alternatively, the button may be promptly pressed three times (S309) to establish a subroutine of voice recording mode (S380). At this point, the subroutine of voice recording mode (S380)is activated to record voice messages through the microphone.

Then, the button may be pressed one more time (S311) to establish searching mode (S390). Alternatively, when the camera is in initial mode (S301), the button may be promptly pressed four times (S311) to establish searching mode (S390). As the input data, such as a specific camera site number and date, is read in, a subroutine of searching mode (S390) is activated to retrieve and display specific information. As the subroutine is completed, the process returns to the main program (S400).

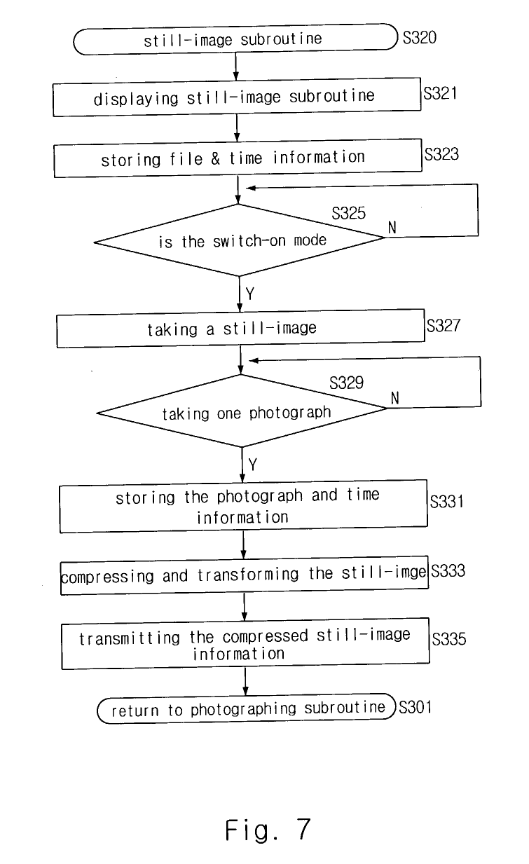

Referring to FIG. 7, a subroutine of still-image mode (S320) is described in great detail. When still-image mode is selected by the operator, the subroutine of still-image mode is displayed on the viewfinder screen (S321). Simultaneously, information such as date and time appears on the screen, and the information is stored in the organized DATE and HOUR files of the memory unit (S323). This organized storage system is convenient and saves time in finding the stored information. Next, the selected camera is checked to determine whether the camera is in switch-on mode for activation (S325). If the selected camera is not in switch-on mode, the camera remains in standby mode while searching for the next available camera. If the selected camera is in switch-on mode (S325), the camera begins photographing via the lens 13 and image-sensing unit 21 (S327).

At this point, the selected camera is signaled to take one photograph (S329). If the selected camera does not take one photograph (S329), the camera remains in standby mode until the next available camera is found. If the selected camera does take one photograph (S329), information such as date and time is stored in the auxiliary memory unit (S331). The control unit 23 compresses and transforms the still-image information stored in the auxiliary memory unit 22 (S333). Then, the compressed still-image information is transmitted to the computer processor via the communication interface 25 and is displayed on the viewfinder screen (S335). As the subroutine is completed, the process returns to the main program (S400).

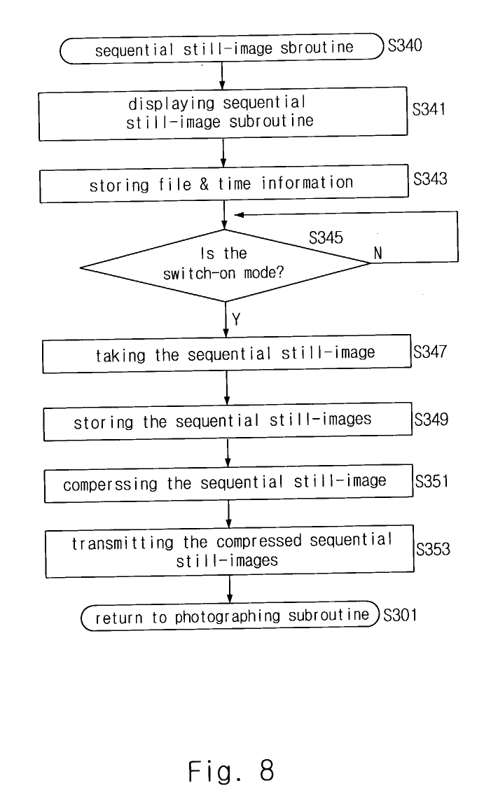

Referring to FIG. 8, a subroutine of sequential still-image (S340) is described in detail. When sequential still-image mode (S340) is established, the subroutine of sequential still-image mode is displayed on the viewfinder screen (S341). Simultaneously, information such as a camera file number, date and time, appears on the screen and is stored in the organized DATE and HOUR files of the memory unit (S343). Next, the selected camera is checked to determine whether it is in switch-on status for activation (S345). If the selected camera is not in switch-on mode, the camera remains in standby mode. Then, it displays an image from the main camera mounted on the computer monitor while it searches for the next available camera. If the selected camera 26 is in switch-on mode, the camera takes a photograph through the lens 13 and the image-sensing unit 21. At this point, the selected camera receives a signal to take a series still-image shots (S347). Then, the sequential still-image and information such as date and time is stored in the auxiliary memory unit (S349). Next, the control unit 23 compresses and transforms the sequential still-image stored in the auxiliary memory unit 22 (S351). Then, the compressed sequential still image is transmitted to the computer processor through the communication interface 25 to display on the viewfinder screen (S353). As the subroutine is completed, the process returns to the main program (S400).

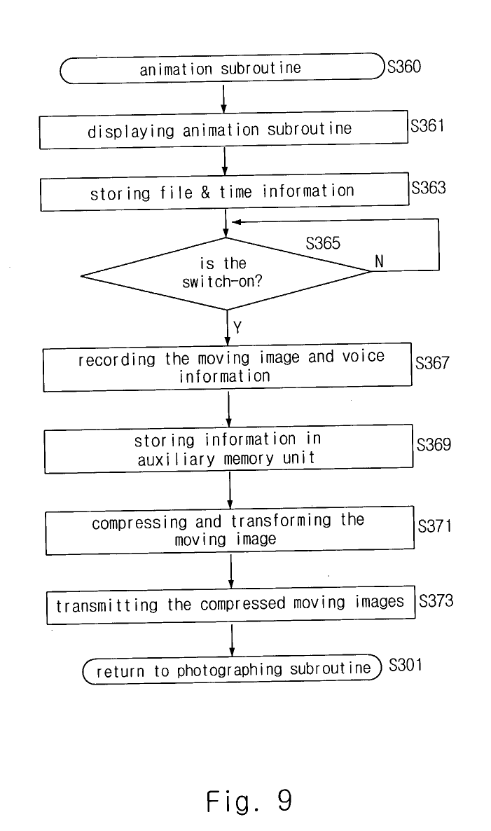

Referring to FIG. 9, a subroutine of animation mode (S360) is described in detail. When animation mode (S360) is selected by the operator, the subroutine of animation mode is displayed on the viewfinder screen (S361). Simultaneously, information such as date and time appears on the screen and is stored in the DATE and HOUR files in the memory unit (S363). Next, the selected camera is checked to determine whether it is in switch-on status for activation (S365). If the selected camera is not in switch-on mode, the camera remains in standby mode. Then, it displays an image from the main camera mounted on the computer monitor while it is searching for the next available camera. If the selected camera is in switch-on mode (S365), according to the operator's instruction, the camera records the moving image via the lens (13) and the image-sensing unit 21 (S367). At the same time, the selected camera records the moving image with information such as date and time in the auxiliary memory unit (S369). Voice information is also simultaneously recorded in the auxiliary memory unit 22 through a microphone. The control unit 23 in the camera 20 compresses and transforms the moving image stored in the auxiliary memory unit 22 (S371). Finally, the compressed sequential moving image is transmitted to the computer processor via the communication interface 25 to display on the viewfinder screen (S373). As the subroutine is completed, the process returns to the main program (S400).

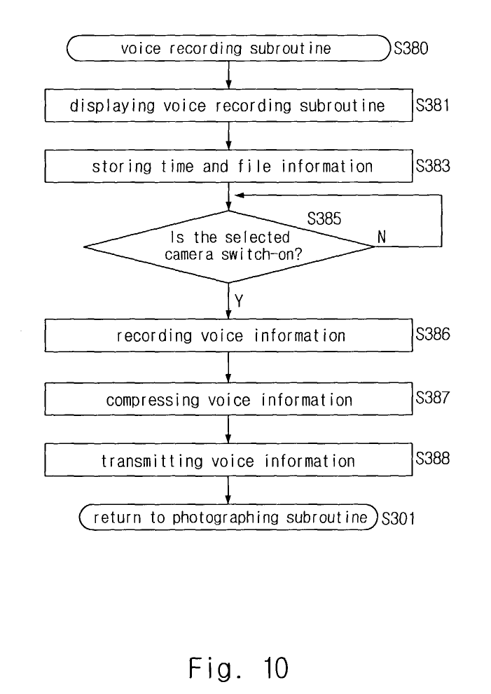

Referring to FIG. 10, a subroutine of voice recording (S380) mode is described in great detail. When voice-recording (S380) mode is selected, the subroutine of voice recording mode (S380) is displayed on the viewfinder screen (S381). Simultaneously, information such as date and time appears on the screen and is stored in the DATE and HOUR files in the memory unit (S383). Next, the selected camera is checked to determine whether it is in switch-on status for activation (S385). If the selected camera is not in switch-on mode, the camera remains in standby mode. Then, it displays an image from the main camera mounted on the computer monitor while it is searching for the next available camera.

If the selected camera is in switch-on mode (S385), according to the operator's instruction, voice information is recorded in the auxiliary memory unit 22 via a microphone on the camera (S386).

The control unit 23 installed inside the camera 20 compresses and transforms the voice information stored in the auxiliary memory unit 22 (S387). Then, the compressed voice information is transmitted to the computer processor via the communication interface 25 (S388). As the subroutine is completed, the process returns to the main program (S400).

Referring to FIG. 11, a subroutine of searching (S390) is described in detail. When the searching (S390) is selected by the operator's instruction, the subroutine of searching mode is displayed on the viewfinder screen (S391). Simultaneously, input data from the DATE and HOUR file of memory unit (S393), such as camera site number and the date or time the image was recorded, is displayed on the screen. From the displayed information, the proper image information is retrieved to display on the screen (S395). As the subroutine is completed, the process returns to the main program (S400).

According to the aforementioned discussion, the multiple cameras with viewfinders of the present invention enable video communication through the Internet.

The present invention has been described in an illustrative manners, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A video communication system employing a plurality of cameras with viewfinders comprises:
a camera (26) with a viewfinder mounted on a computer monitor for recording an image in front of the computer monitor,
a plurality of cameras (26) with viewfinders posted at each site for recording local images and voice information, and
a communication interface (25) interconnecting a computer processor (30) and the plurality of cameras (26) through connecting codes or a wireless system.

2. A video communication system as claimed in claim 1, wherein said camera further comprises:
an image sensing unit (21) internally equipped with an analog-digital (A/D) converter for converting an analog signal of image to a digital signal,
an auxiliary memory unit (22) for temporarily storing the converted digital signal,
a control unit (23) for transmitting the converted digital signal of image to a computer processor (30), and receiving voice information through a microphone (19) for transforming to a voice signal, and
a transforming unit (24) for transforming image and voice information received from the control unit (23) to a standard signal and transmitting the standard signals to the computer processor (30) via the communication interface (25).

3. A process for video communication applied to a computer processor such as a laptop or desktop employing a plurality of cameras with viewfinders, the process comprises steps of:
connecting the computer processor to a selected camera (26) among a plurality of cameras (S100);
activating a software program (S/W) of Corder/Decorder (CODEC) in the computer processor (30) which corresponds to the selected camera (S102);
searching for a DATE file for the selected camera in a memory unit (S104);
determining whether the DATE file of the selected camera exists in the memory unit (S106),
if not, creating a new DATE file to store image information in the memory unit (S107),
inputting data to select either of image communication mode or photographing mode (S108);
setting up a selected mode either of image communication or photographing (S110);
activating selected mode of image communication subroutine (S200) or photographing subroutine (S300); and
receiving and storing image information taken from the selected camera for displaying and monitoring on a viewfinder screen (S400).

4. A process for video communication as claimed in claim 3, wherein said subroutine for image communication is further comprising the steps of:
displaying said subroutine for image communication mode on the viewfinder screen (S201),
selecting a camera among the plurality of cameras, and at the same time, setting switch-on mode for a selected camera (S203),
if the selected camera is not detected in switch-on mode, displaying the image from the main camera mounted on a computer monitor while searching for the next available camera (S204),
if the selected camera is detected in switch-on mode, displaying the image transmitted from the selected camera (S205), and
returning to the main program (S400).

5. A process for video communication as claimed in claim 3, wherein said subroutine for photographing is further comprising the steps of:
displaying said subroutine for photographing mode on the camera viewfinder (S301);
setting button-on mode for said selected camera among the plurality of cameras (S303);
activating a subroutine for still-image (S320);
pressing a button one time (S305) to establish sequential still-image mode (S340);
pressing the button one more time (S307) to establish animation mode (S360); or, alternatively, pressing the button promptly twice (S307) at initial mode (S301) to establish a subroutine of animation mode (S360);
pressing the button one more time (S309) to establish voice recording mode (S380), or, alternatively, pressing the button promptly three times (S309) to establish a subroutine of voice recording mode (S380) from initial mode (S301);
pressing the button one more time (S311) to establish searching mode (S390), or, alternatively, from initial mode (S301), pressing the button promptly four times (S311) to establish searching mode (S390); and
returning to the main program (S400).

6. A process for video communication as claimed in claim 5, wherein said subroutine of still-image (S320), the process is further comprising steps of:
displaying a subroutine for still-image on the viewfinder screen (S321);
storing time information, such as date and time, in DATE and HOUR files of the memory unit (S323);
checking the selected camera to determine whether it is in switch-on mode for activation (S325),
if not, setting the selected camera in standby mode and displaying the image from the main camera while searching for a next available camera,
if the selected camera is in switch-on mode, instructing the selected camera to take a photograph via the lens and image-sensing unit (S327);
taking one photograph (S329), or, if not, setting the selected camera to standby mode and looking for an available camera;
if the selected camera take one photograph, storing the photograph and information of date and time, in the auxiliary memory unit (S331),
compressing and transforming said still-image information stored in the auxiliary memory unit through the control unit (S333),
transmitting the compressed still-image information to the computer processor through the communication interface for displaying on the viewfinder screen (S335), and
returning to subroutine for photographing (S301).

7. A process for video communication as claimed in claim 5, said subroutine of sequential still-image (S340) further comprising the steps of:
displaying the subroutine for sequential still-image on the viewfinder screen (S341);
simultaneously storing information of date and time, as it appears on the screen in DATE and HOUR files in the memory unit (S343);
checking whether the selected camera is in switch-on mode for activation (S345), if not setting the selected camera in standby mode, if it is in switch-on mode,
taking a photograph via the lens and image-sensing unit (S347);
instructing the selected camera to take sequential still-image photographs (S347);
storing the sequential still-images and time information in the auxiliary memory unit (S349);
compressing and transforming the sequential still-images stored in the auxiliary memory unit (S351);
transmitting the compressed sequential still-images to the computer processor via the communication interface to display on the viewfinder screen (S353): and
returning to subroutine for photographing (S301).

8. A process for video communication as claimed in claim 5, wherein said subroutine of animation (S360) is further comprising the steps of:
displaying a subroutine of animation mode on the viewfinder screen (S361);
storing time information in DATE and HOUR files in the memory unit (S363);
checking whether the selected camera is in switch-on status for activation (S365),
if not, setting standby mode for the selected camera, displaying an image from the main camera mounted on the computer monitor,
if the selected camera is in switch-on status, instructing the selected camera to record moving image and voice information (S367);
storing the moving image with sound, as well as time information, such as date and time, in the auxiliary memory unit (S369);
compressing and transforming the stored moving image via the control unit (S371);
transmitting the compressed moving images to the computer processor though the communication interface to display on the viewfinder screen (S373): and
returning to subroutine for photographing (S301).

9. A process for video communication as claimed in claim 5, wherein said subroutine of voice recording (S380) is further comprising the steps of:
displaying a subroutine for voice recording mode on the viewfinder screen (S381);
storing information of date and time that appear on the screen, in DATE and HOUR files in the memory unit (S383);
checking whether the selected camera is in switch-on status for activation (S385),
if not, setting the selected camera in standby mode and finding the next available camera;
if the selected camera is in switch-on mode, recording voice information through a microphone on the camera, and storing it in an auxiliary memory unit (S386);
compressing and transforming the voice information stored in the auxiliary memory unit (S387),
transmitting the compressed voice information to the computer processor through the communication interface (S388), and
returning to subroutine for photographing (S301).

10. A process for video communication as claimed in claim 5, wherein said subroutine for searching (S390) is further comprising the steps of:
displaying a subroutine for searching mode on the viewfinder screen (S391);
inputting data of camera site number and the date the image was recorded (S393);
displaying the information on the viewfinder screen from the DATE file in the memory unit (S395),
retrieving the proper image information on the viewfinder screen (S395), and
returning to subroutine for photographing (S301).
